(19) United States
(12) Patent Application Publication
(10) Pub. No.: US 2026/0169725 A1
(43) Pub. Date: Jun. 18, 2026

(54) CONTROLLER MANAGEMENT APPARATUS AND METHOD

(71) Applicants: HYUNDAI MOTOR COMPANY, Seoul (KR); KIA CORPORATION, Seoul (KR)

(72) Inventors: Yoon Ki Park, Hwaseong-si (KR); Myeong Gyu Jeong, Hwaseong-si (KR); Hak Jun Kim, Hwaseong-si (KR)

(73) Assignees: HYUNDAI MOTOR COMPANY, Seoul (KR); KIA CORPORATION, Seoul (KR)

(21) Appl. No.: 19/228,006

(22) Filed: Jun. 4, 2025

(30) Foreign Application Priority Data
Dec. 16, 2024 (KR) 10-2024-0187741

(51) Int. Cl. G06F 8/65

(52) U.S. Cl. CPC G06F 8/65

(57) ABSTRACT

A controller management apparatus includes a memory storing a computer-executable instruction and a processor configured to accesses the memory and executes the instructions. The processor is configured to receive at least one piece of update request information including priority and urgency from at least one controller after an ignition of a vehicle is deactivated. The processor is also configured to apply the at least one piece of update request information to a target method predetermined to output whether it is possible to perform an update to determine a first target controller to perform an update among the at least one controller. The processor is further configured to perform an update of a second target controller to perform the update subsequently to the first target controller, among the at least one controller, after the update of the first target controller is performed.

### CROSS-REFERENCE TO RELATED APPLICATION

This application claims the benefit of and priority to Korean Patent Application No. 10-2024-0187741, filed on Dec. 16, 2024, the entire contents of which are hereby incorporated herein by reference.

### TECHNICAL FIELD

The present disclosure relates to a controller management apparatus and method.

### BACKGROUND

An over-the-air (OTA) update and feature on demand (FoD) function activation are typically designed to operate in such a manner as to download software or a certificate while driving and receive a customer approval and install the software and the certificate in an IG OFF state of the vehicle. However, such a manner causes logic to be complicated and causes a possibility of malfunction to be high, because installation approval windows are separately displayed in OTA and FoD. A customer expects to install FoD as soon as he or she requests function activation, but there is a possibility of not meeting customer expectations, when FoD is processed in the same manner as OTA.

### SUMMARY

The present disclosure has been made to solve the above-mentioned problems occurring in the prior art while advantages achieved by the prior art are maintained intact. Embodiments of the present disclosure provide a technology in which FoD priority is set to be higher than an OTA priority and an FoD event may be immediately processed according to a purchase request of a customer.

Aspects of the present disclosure provide a controller management apparatus and method for applying update request information to a target method predetermined to output whether it is possible to perform an update to determine a controller to perform an update to first process FoD via priority logic, if an OTA update and an FoD event occur at the same time, and switching OTA to a waiting state to prevent malfunction of system logic.

The technical problems to be solved by the present disclosure are not limited to the aforementioned problems. Other technical problems not mentioned herein should be more clearly understood from the following description by those having ordinary skill in the art to which the present disclosure pertains.

According to an aspect of the present disclosure, a controller management apparatus is provided. The controller management apparatus includes a memory configured to store computer-executable instructions and a processor configured to execute the computer-executable instructions. The processor is configured to receive at least one piece of update request information including priority and urgency from at least one controller after an ignition of a vehicle is deactivated. The processor is also configured to apply the at least one piece of update request information to a target method predetermined to output whether it is possible to perform an update to determine a first target controller to perform an update among the at least one controller. The processor is further configured to perform an update of a second target controller to perform the update subsequently to the first target controller, among the at least one controller, after the update of the first target controller is performed.

In an embodiment, the processor may be configured to receive the at least one piece of update request information, during a predetermined time interval after the ignition of the vehicle is deactivated, and may transmit a result obtained from the target method to each of the at least one controller.

In an embodiment, the processor may be configured to apply the at least one piece of update request information to the target method to obtain whether it is possible to proceed with an update of each of the at least one piece of update request information. The processor may also be configured to determine a controller associated with the update request information determined that it is possible to proceed with the update among the at least one piece of update request information as the first target controller. The processor may further be configured to change urgency included in update request information associated with the first target controller, based on that the update of the first target controller is rejected.

In an embodiment, the processor may be configured to determine whether there is a software release for the second target controller, if the first target controller is a feature on demand (FoD) controller and the second target controller is an update management controller.

In an embodiment, the processor may be configured to change urgency of the second target controller to a predetermined value, based on determining that there is the software release for the second target controller, and may be configured to determine a state of the second target controller as an idle state, based on determining that there is no software release for the second target controller.

In an embodiment, the processor may be configured to identify a state of the first target controller and a state of the second target controller, if the first target controller is an over-the-air (OTA) management controller and the second target controller is an FoD controller.

In an embodiment, the processor may be configured to perform the update of the first target controller, if the state of the first target controller is an initial state and the state of the second target controller is an idle state.

In an embodiment, the processor may be configured to control the update of the second target controller to precede the update of the first target controller, if the state of the first target controller is an initial state and the state of the second target controller is not an idle state.

According to another aspect of the present disclosure, a controller management method is provided. The controller management method includes receiving at least one piece of update request information including priority and urgency from at least one controller after an ignition of a vehicle is deactivated. The controller management method also includes applying the at least one piece of update request information to a target method predetermined to output whether it is possible to perform an update to determine a first target controller to perform an update among the at least one controller. The controller management method additionally includes performing an update of a second target controller to perform the update subsequently to the first target controller, among the at least one controller, after the update of the first target controller is performed.

In an embodiment, the controller management method may further include receiving the at least one piece of update request information, during a predetermined time interval after the ignition of the vehicle is deactivated, and transmitting a result obtained from the target method to each of the at least one controller.

In an embodiment, the controller management method may further include applying the at least one piece of update request information to the target method to obtain whether it is possible to proceed with an update of each of the at least one piece of update request information, determining a controller associated with the update request information determined that it is possible to proceed with the update among the at least one piece of update request information as the first target controller, and changing urgency included in update request information associated with the first target controller, based on that the update of the first target controller is rejected.

In an embodiment, the controller management method may further include determining whether there is a software release for the second target controller, if the first target controller is a feature on demand (FoD) controller and the second target controller is an update management controller.

In an embodiment, the controller management method may further include changing urgency of the second target controller to a predetermined value, based on determining that there is the software release for the second target controller, and determining a state of the second target controller as an idle state, based on determining that there is no software release for the second target controller.

In an embodiment, the controller management method may further include identifying a state of the first target controller and a state of the second target controller, if the first target controller is an over-the-air (OTA) management controller and the second target controller is an FoD controller.

In an embodiment, the controller management method may further include performing the update of the first target controller, if the state of the first target controller is an initial state and the state of the second target controller is an idle state.

In an embodiment, the controller management method may further include controlling the update of the second target controller to precede the update of the first target controller, if the state of the first target controller is an initial state and the state of the second target controller is not an idle state.

### BRIEF DESCRIPTION OF THE DRAWINGS

The above and other objects, features, and advantages of the present disclosure should be more apparent from the following detailed description taken in conjunction with the accompanying drawings, in which:

FIG. 1 is a drawing illustrating a block diagram of a controller management apparatus, according to an embodiment of the present disclosure;

FIG. 2 is a flowchart for describing a controller management method, according to embodiment of the present disclosure;

FIG. 3 is a drawing for describing a method for determining an update order between an update management controller and an FoD controller in a controller management apparatus, according to embodiment of the present disclosure;

FIG. 4 is a drawing illustrating an example of a state of an OTA management controller and a state of an FoD controller, according to embodiment of the present disclosure; and

FIG. 5 is a drawing illustrating a computing system associated with a controller management apparatus or a controller management method, according to an embodiment of the present disclosure.

With regard to description of drawings, the same or similar components are designated by the same or similar reference numerals.

### DETAILED DESCRIPTION

Hereinafter, embodiments of the present disclosure are described in detail with reference to the accompanying drawings. In adding the reference numerals to the components of each drawing, it should be noted that the identical components are designated by the identical numerals even when the components are displayed on different drawings. Further, in describing the embodiment of the present disclosure, where it was determined that a detailed description of well-known features or functions would obscure the gist of the present disclosure, the detailed description thereof has been omitted. Hereinafter, various embodiments of the present disclosure may be described with reference to the accompanying drawings. However, it should be understood that this is not intended to limit the present disclosure to specific implementation forms and includes various modifications, equivalents, and/or alternatives of embodiments of the present disclosure. With regard to description of drawings, similar components may be marked by similar reference numerals.

In describing components of embodiments of the present disclosure, the terms first, second, A, B, (a), (b), and the like may be used herein. These terms are only used to distinguish one component from another component. These terms do not limit the corresponding components irrespective of the order or priority of the corresponding components. Furthermore, unless otherwise defined, all terms including technical and scientific terms used herein have the same meaning as generally understood by those having ordinary skill in the art to which the present disclosure pertains. Such terms as those defined in a generally used dictionary should be interpreted as having meanings equal to the contextual meanings in the relevant field of art, and are not to be interpreted as having ideal or excessively formal meanings unless clearly defined as having such in the present disclosure.

Terms, such as “first”, “second”, “1st”, “2nd”, or the like may be used in the present disclosure. These terms may be used to refer to various components regardless of the order and/or the priority and to distinguish one component from another component. These terms do not limit the corresponding components irrespective of the nature, order, or priority of the corresponding elements. For example, “a first user device” and “a second user device” may indicate different user devices regardless of the order or priority thereof. For example, without departing the scope of the present disclosure, a first component may be referred to as a second component, and similarly, a second component may be referred to as a first component.

In the present disclosure, the expressions “have”, “may have”, “include” and “comprise”, or “may include” and “may comprise” indicate existence of corresponding features (e.g., components such as numeric values, functions, operations, or parts), but do not exclude presence of additional features.

It should be understood that when a component (e.g., a component) is referred to as being “(operatively or communicatively) coupled with/to” or “connected with/to” another component (e.g., a second component), the component may be directly coupled with/to or connected with/to the other component or one or more intervening components (e.g., a third component) may be present. In contrast, when a component (e.g., a first component) is referred to as being “directly coupled with/to” or “directly connected with/to” another component (e.g., a second component), it should be understood that there is no intervening component (e.g., a third component).

In the present disclosure, when a component, controller, device, element, apparatus, unit or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, server, and the like may separately embody or be included with a processor and a memory, such as a non-transitory computer readable media, as part of the apparatus.

According to the situation, the expression “configured to” used in the present disclosure may be used interchangeably with, for example, the expression “suitable for”, “having the capacity to”, “designed to”, “adapted to”, “made to”, or “capable of”.

The term “configured to” should not be interpreted to mean only “specifically designed to” in hardware. For example, the expression “a device configured to” may mean that the device is “capable of” operating together with another device or other parts. For example, a “processor configured to perform A, B, and C” may mean a generic-purpose processor (e.g., a central processing unit (CPU) or an application processor) that may perform corresponding operations by executing one or more software programs that store a dedicated processor (e.g., an embedded processor) for performing a corresponding operation or a memory device. Terms used in the present disclosure are used to describe specified embodiments and are not intended to limit the scope of the present disclosure. The terms of a singular form may include plural forms unless the context clearly indicates otherwise. All the terms used herein, which include technical or scientific terms, may have the same or equivalent meaning that is generally understood by a person having ordinary skill in the art to which the present disclosure pertains. It should be further understood that terms that are defined in a dictionary and commonly used should also be interpreted as is customary in the relevant related art. The terms should not be interpreted in an idealized or overly formal detect unless expressly so defined herein in various embodiments of the present disclosure. In some cases, even when terms are defined in the present disclosure, the terms may not be interpreted to exclude embodiments of the present disclosure.

In the present disclosure, the expressions “A or B”, “at least one of A or/and B”, or “one or more of A or/and B”, and the like may include any and all combinations of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included. Furthermore, in describing embodiments of the present disclosure, each of such phrases as “A or B”, “at least one of A and B”, “at least one of A or B”, “A, B, or C”, “at least one of A, B, and C”, “at least one of A, B, or C”, and “at least one of A, B, or C, or any combination thereof” may include any one of, or all possible combinations of the items enumerated together in a corresponding one of the phrases. For example, the phrase such as “at least one of A, B, or C, or any combination thereof” may include “A”, “B”, or “C”, or “AB” or “ABC”, which is a combination thereof.

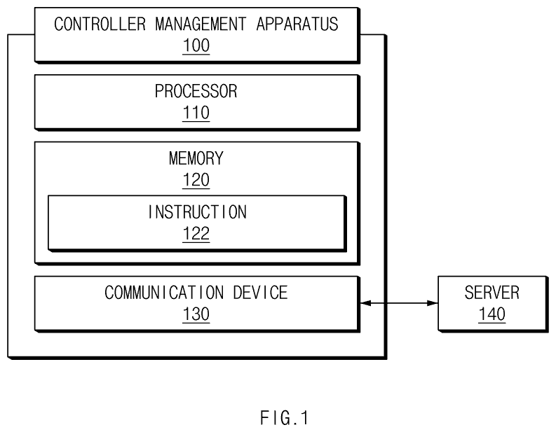

Hereinafter, embodiments of the present disclosure are described in detail with reference to FIGS. 1-5.

FIG. 1 is a drawing illustrating a block diagram of a controller management apparatus according to an embodiment of the present disclosure.

A controller management apparatus 100 according to an embodiment may include a processor 110, a memory 120 including an instruction 122, and a communication device 130.

The controller management apparatus 100 may be a device for determining update priorities of controllers included in a vehicle.

For example, the controller management apparatus 100 may efficiently manage update requests of the controllers in the vehicle and may control priorities between feature on demand (FoD) and over-the-air (OTA) management modules.

For example, the controller management apparatus 100 may receive update request information from at least one controller in a state in which the ignition of the vehicle is deactivated. Priority and urgency may be included in the update request information.

In an example, the controller management apparatus 100 may apply the update request information to a predetermined method to determine whether it is possible to perform an update and may determine a first target controller to perform an update based on the information.

For example, if the update of the first target controller is completed, the controller management apparatus 100 may determine a second target controller to subsequently perform an update and may sequentially perform the update.

In an embodiment, the controller management apparatus 100 may identify states of an FoD controller and an OTA management controller and may dynamically adjust priorities between the two controllers. If the FoD controller is in an active state, the controller management apparatus 100 may control to process an update of the FoD controller to precede an OTA update. If the FoD controller is in an idle state, the controller management apparatus 100 may proceed with an OTA update. The controller management apparatus 100 may quickly process a customer request (i.e., an FoD event) via priority management logic and may prevent a collision of the OTA update.

For example, the controller management apparatus 100 may efficiently manage FoD and OTA events of the vehicle based on priority and urgency and may implement an update process without collision. As a result, the controller management apparatus 100 may quickly reflect a customer request, may maintain stability and efficiency of a vehicle system, and may improve a user experience.

The processor 110 may execute software and may control at least one other component (e.g., a hardware or software component) connected with the processor 110. In addition, the processor 110 may perform a variety of data processing or computation. For example, the processor 110 may store the update request information in the memory 120.

In an embodiment, the processor 110 may perform all operations performed by the controller management apparatus 100. Therefore, for convenience of description in the specification, the operation performed by the controller management apparatus 100 is mainly described as an operation performed by the processor 110. Furthermore, for convenience of description in the specification, the processor 110 is mainly described as, but not limited to, one processor. In various example, the controller management apparatus 100 may include one or more processors. Each of the one or more processors may perform operations (e.g., all operations) associated with a controller management operation.

The memory 120 may temporarily and/or permanently store various pieces of data and/or information required to perform the controller management operation. For example, the memory 120 may store the update request information.

The communication device 130 may enable communication between the controller management apparatus 100 and a server 140. For example, the communication device 130 may include one or more components for performing communication between the controller management apparatus 100 and the server 140. For example, the communication device 130 may include a short range wireless communication unit, a microphone, or the like. In an embodiment, a short range communication technology may be, but is not limited to, a wireless LAN (Wi-Fi), Bluetooth, ZigBee, Wi-Fi Direct (WFD), ultra-wideband (UWB), infrared data association (IrDA), Bluetooth low energy (BLE), near field communication (NFC), or the like.

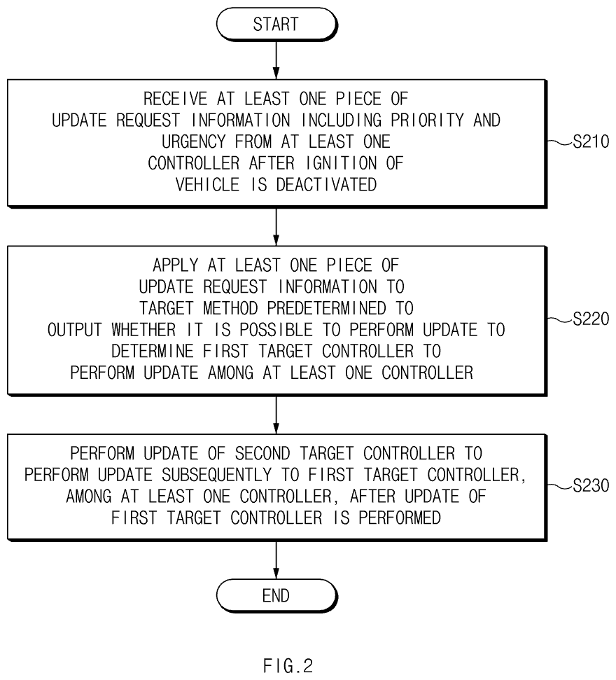

FIG. 2 is a flowchart for describing a controller management method according to embodiment of the present disclosure.

In an operation S210, a processor (e.g., the processor 110 of FIG. 1) according to an embodiment may receive at least one piece of update request information including priority and urgency from at least one controller after the ignition of a vehicle is deactivated.

For example, the at least one controller may refer to a control device capable of requesting or receiving a software update in the vehicle, which may include various types of controllers, such as a feature on demand (FoD) controller and an over-the-air (OTA) management controller. The at least one controller may be a device for transmitting software update request information or executing an update, which may include all control devices necessary for function and performance improvement of the vehicle. Each controller may be managed via unique update request information (e.g., priority, urgency, or the like).

The priority may be a value indicating relative importance of a request in the update request information received from the at least one controller. The priority may be used to determine an execution order between the pieces of update request information and may indicate a higher priority as its value is lower. The priority may be preset or dynamically adjusted according to the requested controller and software to ensure an efficient operation of the system.

The urgency may be a value indicating how quickly the update needs to be performed in the update request information received from the at least one controller. The urgency may be used to compare temporal urgency between events, such as feature on demand (FoD) and over-the-air (OTA), and reflect influence if a specific update is postponed to dynamically adjust an update order. The urgency may vary in value depending on a situation, such as update rejection. A request with high urgency may have an influence on determining an update process together with the priority.

The update request information may be information received from the at least one controller, after the ignition of the vehicle is deactivated. The update request information may include details of a software update requested by the controller. For example, the update request information may include a value (i.e., the priority) indicating relative importance of an update request, a value (i.e., the urgency) indicating temporal urgency of the update request, and identification information of a specific controller associated with the request. The update request information may be used as reference data for causing the processor to evaluate each update request and perform an update in an optimal order.

In an operation S220, the processor may apply the at least one piece of update request information to a target method predetermined to output whether it is possible to perform an update to determine a first target controller to perform an update among the at least one controller.

For example, the target method may indicate a logical operation or procedure predefined to process priority and urgency information input from the at least one piece of update request information and output whether it is possible to perform an update of the request. The processor may obtain whether it is possible to execute update request information of each controller (True/False) from the target method to determine the first target controller to perform the update. For example, the target method may operate based on attributes (e.g., priority and urgency) included in the update request information. The target method may return whether it is possible to perform an update (True/False) depending on a specific condition. The target method may be used to prevent an update collision between controllers and determine an efficient execution order.

In an example, the first target controller may indicate a controller to first perform an update among controllers in which whether is possible to perform the update is determined as “True” by the target method. The first target controller may indicate a controller that preferentially performs an update by the target method. The processor may sequentially perform an update of another controller (e.g., a second target controller or the like). The first target controller may be selected based on a priority value and an urgency value. The priority or the urgency may be adjusted according to a change (e.g., rejection or the like) in state of the first target controller.

In an operation S230, the processor may perform an update of a second target controller to perform the update subsequently to the first target controller, among the at least one controller, after the update of the first target controller is performed.

For example, the second target controller may refer to a controller that subsequently should perform an update, after the update of the first target controller is completed. The second target controller may be selected to perform a subsequent update. A function and a requirement of the controller may be dynamically reflected according to an update order. The second target controller may be determined according to criteria, such as whether it is possible to perform an update (True/False), priority, or urgency. The second target controller may vary in update ranking depending on a specific condition (e.g., rejection or whether there is a software release).

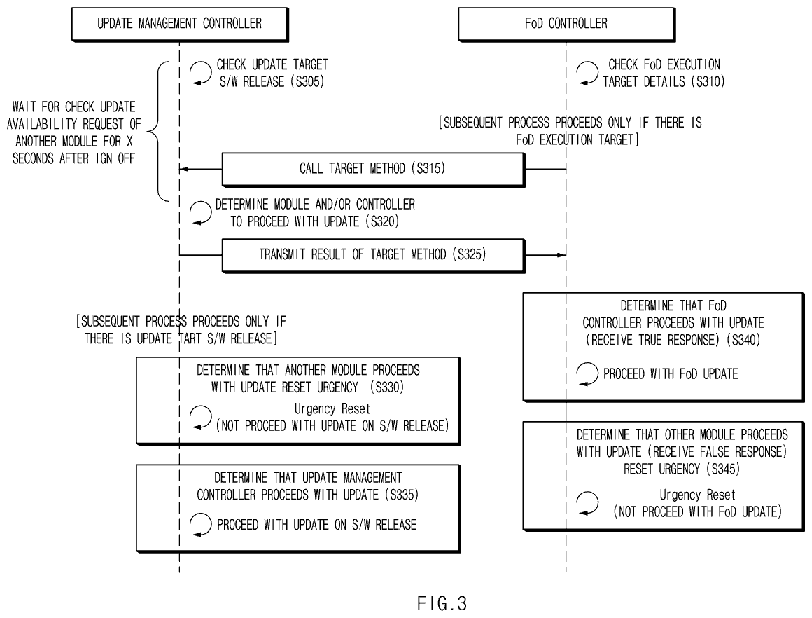

FIG. 3 is a drawing for describing a method for determining an update order between an update management controller and an FoD controller, in a controller management apparatus according to embodiment of the present disclosure.

A processor (e.g., the processor 110 of FIG. 1) according to embodiment may determine a first target controller and a second target controller among at least one controller and may determine update orders of the first target controller and the second target controller. Hereinafter, with reference to FIG. 3, a description is given of operational flow of the first target controller (e.g., an FoD controller) and the second target controller (e.g., an update management controller), the update orders of which are determined by the processor.

In an embodiment, the update management controller may be implemented with the same components as a controller management apparatus (e.g., the controller management apparatus 100 of FIG. 1). In an embodiment, the update management controller may take charge of receiving pieces of update request information generated by various controllers in a vehicle and managing and processing them. This may be the same as a function provided by the controller management apparatus 100 or may be integrated into it. Thus, for convenience of description in FIG. 3, it is described that the controller management apparatus and an update management device are the same as each other.

In an operation S305, the update management controller may check an update target software (S/W) release. The update management controller may receive update request information from another module (e.g., an FoD controller), while waiting during a predetermined time interval after IGN OFF, and may check whether there is an update target S/W release.

If there is no S/W release, the update management controller may end the operation. If there is the S/W release, the update management controller may perform the next operation (e.g., an operation S315).

If identifying that there is no S/W release for the second target controller (i.e., the update management controller), the update management controller may determine the state of the second target controller as an idle state.

In an operation S310, the FoD controller may check FoD execution target details. For example, the FoD controller may check whether there is an FoD execution target request. If there is no FoD execution target, the FoD controller may fail to perform a subsequent operation. If there is the FoD execution target, the FoD controller may deliver information to the update management controller and may perform the next operation (e.g., the operation S315).

In the operation S315, the FoD controller may call a target method. For example, the update management controller may determine whether it is possible to perform an update of a controller (e.g., the FoD controller in FIG. 3) which transmits update request information (including priority and urgency), via the target method, based on the update request information. The update management controller may evaluate the request information input via the target method and may determine a module and/or a controller capable of proceeding with an update.

For example, the update management controller may receive at least one piece of update request information, during a predetermined time interval after the ignition of the vehicle is deactivated. The update management controller may transmit a result obtained from the target method to each of the at least one controller.

For example, the update management controller may apply the at least one piece of update request information to the target method to obtain whether it is possible to proceed with an update of each of the at least one piece of update request information. The update management controller may determine a controller associated with the update request information determined that it is possible to proceed with the update among the at least one piece of update request information as a first target controller.

In an operation S320, the update management controller may determine a module and/or a controller to proceed with an update. For example, the update management controller may determine a control module (e.g., an FoD controller or another module) to execute an update, based on the result of the target method. The selected module may be the first target controller (i.e., the FoD controller) and may be another module.

For example, if the first target controller is the FoD controller and the second target controller is the update management controller, the update management controller may identify an S/W release for the second target controller.

In an operation S325, the update management controller may transmit the result of the target method. For example, the update management controller may transmit the result (True/False) derived from the target method to the FoD controller. In an embodiment, the True response may refer to a response determined that the controller proceeds with an update and the False response may mean that the controller does not perform an update and proceeds to the next request.

In an operation S330, the update management controller may reset urgency of a request of the update management controller, if it is determined that the other module (i.e., the FoD controller) proceeds with the update. In this case, the update management controller may fail to perform an S/W release update and may transmit an update request to another controller.

For example, based on determining that there is the S/W release for the second target controller, the update management controller may change urgency of the second target controller to a predetermined value (e.g., “0”).

In an operation S335, the update management controller may perform an update on the S/W release, if it is determined that the update management controller proceeds with the update.

In an operation S340, the FoD controller may perform an FoD-related software update, if it is determined that the FoD controller is able to perform the update via the True response result of the target method.

In an operation S345, the FoD controller may reset urgency, if whether to proceed with the update responds as False from the update management controller. The FoD controller may fail to perform an update in this state and may switch to a waiting state.

For example, the FoD controller may change urgency included in the update request information associated with the first target controller (e.g., change to “0”), based on that the update of the first target controller (i.e., the FoD controller) is rejected.

The operation of the update management controller is not limited thereto. For another example, if the first target controller is the OTA management controller and the second target controller is the FoD controller, the update management controller may identify a state of the first target controller and a state of the second target controller. If the state of the first target controller is an initial (init) state and the state of the second target controller is an idle state, the update management controller may perform an update of the first target controller. If the state of the first target controller is the init state and the state of the second target controller is not the idle state, the update management controller may control an update of the second target controller to precede the update of the first target controller.

An over-the-air (OTA) management controller may be a control device in the vehicle, which controls and manages an OTA update process, which may perform a function of remotely downloading and installing software (S/W) and firmware. The OTA management controller may check whether there is update target software and may provide information for determining whether it is possible to perform an update. The OTA management controller may transmit update request information (including priority and urgency) to the update management controller (or the controller management apparatus) to perform an update. The OTA management controller may exchange state information, such as an idle state or an init state, with the update management controller to adjust priority.

The feature on demand (FoD) controller may be a control device in the vehicle, which processes an FoD function activation and deactivation event, which may play a role in immediately activating or deactivating a specific function depending on a customer request. The FoD controller may check whether there is an FoD execution target request and may identify execution target details. If there is no FoD execution target, the FoD controller may stop a subsequent operation.

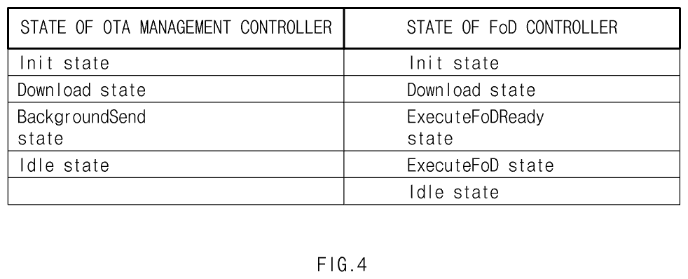

FIG. 4 is a drawing illustrating an example of a state of an OTA management controller and a state of an FoD controller.

FIG. 4 is a table indicating states of an OTA management controller and an FoD controller, that illustrates state definition each controller is able to have in an update and function activation process.

The OTA management controller may have the following state to perform a software update. A first state (e.g., an init state) is an initial state, which indicates a state in which the OTA management controller prepares for an update process. A second state (e.g., a download state) indicates a state for downloading software (S/W) data from a server. In this state, data transmission is not stopped to be continuously performed. A third state (e.g., a BackgroundSend state) indicates a state for transmitting a software update file in the background. It is designed such that an OTA update is not stopped even in an IG OFF state of a vehicle to ensure efficient update transmission. A fourth state (e.g., an idle state) indicates a state in which an update task is completed or waiting. In this state, it may wait to receive an additional update request.

The FoD controller may have the following state to perform vehicle function activation. A first state (e.g., an init state) is an initial state, which indicates a step in which the FoD controller checks whether there is an FoD event request. If an FoD execution target is checked, it proceeds with the next state. A second state (e.g., a download state) indicates a state for downloading data necessary for FoD function activation. The second state may play a similar role to the download state of the OTA management controller. A third state (e.g., an ExecuteFoDReady state) is an FoD execution ready state, which indicates a state in which the FoD controller completes final preparation for function activation. In this state, the FoD controller may compare priorities with the OTA management controller to determine whether to execute it. A fourth state (e.g., an ExecuteFoD state) indicates a state in which an FoD function is actually activated or deactivated. The FoD function may be performed by a customer request and may be processed earlier than an OTA update. A fifth state (e.g., an idle state) is a state in which the FoD controller is waiting, which is maintained if there is no function activation or update request.

For example, that the state of the FoD controller is not the fifth state may indicate that an FoD event is not checked or an FoD event is in progress. That the state of the FoD controller is the fifth state may indicate that there is no FoD event (that the FoD event is able to end, but this is after IGN OFF). That the state of the OTA management controller is the third state may indicate a state in which OTA is proceeding with BackgroundSend and is determined as a state in which it is impossible to proceed with FoD at a time point of IGN ON after IGN OFF.

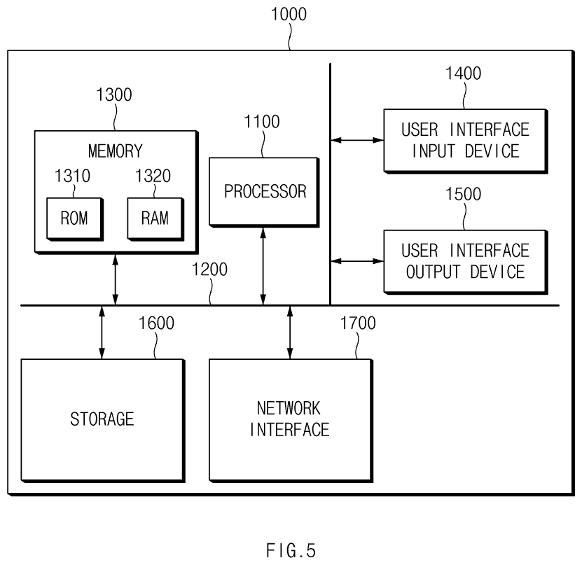

FIG. 5 is a drawing illustrating a computing system associated with a controller management apparatus or a controller management method according to an embodiment of the present disclosure.

Referring to FIG. 5, a computing system 1000 that may be used to implement the controller management apparatus or the controller management method may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the operations of the method or algorithm described in connection with the embodiments of the present disclosure may be directly implemented with a hardware module, a software module, or a combination of the hardware module and the software module, which is executed by the processor 1100. The software module may reside on a storage medium (e.g., the memory 1300 and/or the storage module 1600) such as a RAM, a flash memory, a ROM, an EPROM, an EEPROM, a register, a hard disc, a removable disk, and a CD-ROM.

The storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another embodiment, the processor and the storage medium may reside in the user terminal as separate components.

Hereinabove, although the present disclosure has been described with reference to certain embodiments and the accompanying drawings, the present disclosure is not limited thereto. Rather, the present disclosure may be variously modified and altered by those having ordinary skill in the art to which the present disclosure pertains without departing from the spirit and scope of the present disclosure claimed in the following claims.

The above-described embodiments may be implemented with hardware components, software components, and/or a combination of hardware components and software components. For example, the devices, methods, and components described in the embodiments may be implemented using general-use computers or special-purpose computers, such as a processor, a controller, an arithmetic logic unit (ALU), a digital signal processor, a microcomputer, a field programmable array (FPGA), a programmable logic unit (PLU), a microprocessor, or any device which may execute instructions and respond. A processing unit may perform an operating system (OS) or a software application running on the OS. Further, the processing unit may access, store, manipulate, process and generate data in response to execution of software. It should be understood by those having ordinary skill in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively instruct the processing unit. Software and/or data may be permanently or temporarily embodied in any type of machine, component, physical equipment, virtual equipment, computer storage medium or unit or transmitted signal waves so as to be interpreted by the processing unit or to provide instructions or data to the processing unit. Software may be dispersed throughout computer systems connected over networks and be stored or executed in a dispersion manner. Software and data may be recorded in one computer-readable storage media.

The methods according to embodiments may be implemented in the form of program instructions which may be executed through various computer means and may be recorded in computer-readable media. The computer-readable media may include program instructions, data files, data structures, and the like alone or in combination, and the program instructions recorded on the media may be specially designed and configured for an example or may be known and usable to those having ordinary skill in the art to which the present disclosure pertains. Examples of computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Examples of computer programs include not only machine language codes created by a compiler, but also high-level language codes that are capable of being executed by a computer by using an interpreter or the like.

The above-described hardware devices may be configured to act as one or a plurality of software modules to perform the operations of the embodiments, or vice versa.

Even though the embodiments are described with reference to restricted drawings, it should be apparent to one having ordinary skill in the art that the embodiments may be variously changed or modified based on the above description. For example, adequate effects may be achieved even if the foregoing processes and methods are carried out in different order than described above, and/or the aforementioned components, such as systems, structures, devices, or circuits, are concatenated or coupled in different forms and modes than as described above or be substituted or switched with other components or equivalents.

A description is given below of the effects of the controller management apparatus and the method thereof according to embodiments of the present disclosure.

According to at least one embodiment of the present disclosure, the controller management apparatus may apply update request information to a target method predetermined to output whether it is possible to perform an update to determine a controller to perform an update to first process FoD via priority logic, if an OTA update and an FoD event occur at the same time, and may switch OTA to a waiting state to prevent malfunction of system logic.

In addition, various effects ascertained directly or indirectly through the present disclosure may be provided.

Therefore, other implements, other embodiments, and equivalents to claims are within the scope of the following claims.

Therefore, embodiments of the present disclosure are not intended to limit the technical spirit of the present disclosure. Rather, the embodiments are provided only for the illustrative purpose. The scope of the present disclosure should be construed on the basis of the accompanying claims, and all the technical ideas within the scope equivalent to the claims should be included in the scope of the present disclosure.

What is claimed is:

1. A controller management apparatus, comprising:
a memory storing computer-executable instructions; and
a processor configured to access the memory and execute the computer-executable instructions,
wherein the processor is configured to:
receive at least one piece of update request information including priority and urgency from at least one controller after an ignition of a vehicle is deactivated,
apply the at least one piece of update request information to a target method predetermined to output whether it is possible to perform an update, to determine a first target controller to perform an update among the at least one controller, and
perform an update of a second target controller to perform the update subsequently to the first target controller, among the at least one controller, after the update of the first target controller is performed.

2. The controller management apparatus of claim 1, wherein the processor is configured to:
receive the at least one piece of update request information during a predetermined time interval after the ignition of the vehicle is deactivated; and
transmit a result obtained from the target method to each of the at least one controller.

3. The controller management apparatus of claim 1, wherein the processor is configured to:
apply the at least one piece of update request information to the target method to determine whether it is possible to proceed with an update of each of the at least one piece of update request information;
determine a controller associated with the update request information for which it is determined that it is possible to proceed with the update, among the at least one piece of update request information, as the first target controller; and
change urgency included in update request information associated with the first target controller, based on determining that the update of the first target controller is rejected.

4. The controller management apparatus of claim 1, wherein the processor is configured to:
determine whether there is a software release for the second target controller, based on determining that the first target controller is a feature on demand (FoD) controller and the second target controller is an update management controller.

5. The controller management apparatus of claim 4, wherein the processor is configured to:
change urgency of the second target controller to a predetermined value, based on determining that there is the software release for the second target controller; and
determine a state of the second target controller as an idle state, based on determining that there is no software release for the second target controller.

6. The controller management apparatus of claim 1, wherein the processor is configured to:
determine a state of the first target controller and a state of the second target controller, based on determining that the first target controller is an over-the-air (OTA) management controller and the second target controller is an FoD controller.

7. The controller management apparatus of claim 6, wherein the processor is configured to:
perform the update of the first target controller, based on determining that the state of the first target controller is an initial state and the state of the second target controller is an idle state.

8. The controller management apparatus of claim 6, wherein the processor is configured to:
control the update of the second target controller to precede the update of the first target controller, based on determining that the state of the first target controller is an initial state and the state of the second target controller is not an idle state.

9. A controller management method, comprising:
receiving at least one piece of update request information including priority and urgency from at least one controller after an ignition of a vehicle is deactivated;
applying the at least one piece of update request information to a target method predetermined to output whether it is possible to perform an update, to determine a first target controller to perform an update among the at least one controller; and
performing an update of a second target controller to perform the update subsequently to the first target controller, among the at least one controller, after the update of the first target controller is performed.

10. The controller management method of claim 9, wherein:
receiving the at least one piece of update request information comprises receiving the at least one piece of update request information during a predetermined time interval after the ignition of the vehicle is deactivated; and
the controller management method further comprises transmitting a result obtained from the target method to each of the at least one controller.

11. The controller management method of claim 9, further comprising:
applying the at least one piece of update request information to the target method to determine whether it is possible to proceed with an update of each of the at least one piece of update request information;
determining a controller associated with the update request information for which it is determined that it is possible to proceed with the update among the at least one piece of update request information as the first target controller; and
changing urgency included in update request information associated with the first target controller, based on determining that the update of the first target controller is rejected.

12. The controller management method of claim 9, further comprising:
determining whether there is a software release for the second target controller, based on determining the first target controller is a feature on demand (FoD) controller and the second target controller is an update management controller.

13. The controller management method of claim 12, further comprising:
changing urgency of the second target controller to a predetermined value, based on determining that there is the software release for the second target controller; and
determining a state of the second target controller as an idle state, based on determining that there is no software release for the second target controller.

14. The controller management method of claim 9, further comprising:
determining a state of the first target controller and a state of the second target controller, based on determining that the first target controller is an over-the-air (OTA) management controller and the second target controller is an FoD controller.

15. The controller management method of claim 14, further comprising:
performing the update of the first target controller, based on determining that the state of the first target controller is an initial state and the state of the second target controller is an idle state.

16. The controller management method of claim 14, further comprising:
controlling the update of the second target controller to precede the update of the first target controller, based on determining that the state of the first target controller is an initial state and the state of the second target controller is not an idle state.
